(19) United States
(12) Patent Application Publication
(10) Pub. No.: US 2025/0188765 A1
(43) Pub. Date: Jun. 12, 2025

(54) CANOPY BOW ASSEMBLY SECURED BY A SNAP CLIP

(71) Applicant: WONDERLAND SWITZERLAND AG, Steinhausen (CH)

(72) Inventor: Jonathan M. Pacella, Gap, PA (US)

(73) Assignee: WONDERLAND SWITZERLAND AG, Steinhausen (CH)

(21) Appl. No.: 19/056,050

(22) Filed: Feb. 18, 2025

Related U.S. Application Data
(63) Continuation of application No. 17/781,939, filed on Jun. 2, 2022, now Pat. No. 12,258,774.
(60) Provisional application No. 62/943,409, filed on Dec. 4, 2019.

(51) Int. Cl. E04H 15/64; A47C 7/66; A47C 29/00; A47D 13/06; A47D 15/00; E04H 15/40; F16B 7/04

(52) U.S. Cl. CPC E04H 15/64; A47C 7/66; A47C 29/003; A47D 13/063; A47D 15/00; E04H 15/40; F16B 7/0433

(57) ABSTRACT

A snap clip adapted to mount a canopy bow to an article of furniture including a tube includes a socket and a clip body. The socket defines a mounting space adapted for the canopy bow to be mounted therein. The clip body is connected to the socket and is removably mounted to the tube. The clip body defines a retaining space facing inwardly toward an interior of the article of furniture and adapted for retaining the tube.

### CROSS-REFERENCE TO RELATED APPLICATION

This application is a continuation of U.S. patent application Ser. No. 17/781,939 filed Jun. 2, 2022, which is a 371 National Stage Entry of PCT Application No. PCT/EP2020/083517, filed on Nov. 26, 2020, which claims the benefit of U.S. Provisional Patent Application No. 62/943,409, filed on Dec. 4, 2019, the entire disclosures of which are each incorporated by reference herein.

### FIELD

The disclosure relates to a snap clip, and more particularly to a snap clip for mounting a canopy bow (a bow-like component to which the canopy is to be attached) to an article of furniture.

### BACKGROUND

Currently, there are several playards on the market for outdoor use that include canopies. These canopies are usually attached to top corners of the playard, which are covered by soft goods (such as fabrics). This way of attachment is problematic: it can be difficult for the caregiver to determine where exactly the canopy is to be mounted. Further, when attaching the canopy over the soft goods, secure attachment of a canopy clip may not be ensured because of the gaps among multiple layers of fabric. This may cause the canopy to detach inadvertently by wind or the occupant of the playard pulling on the canopy. For example, commercially available playard canopies may either be pulled off from the playards or be pulled inside of the playards by the occupants.

### SUMMARY

Therefore, an object of the disclosure is to provide a snap clip that can alleviate at least one of the drawbacks of the prior art.

According to the disclosure, the snap clip is adapted to mount a canopy bow to an article of furniture including a tube, and includes a socket and a clip body. The socket defines a mounting space adapted for the canopy bow to be mounted therein. The clip body is connected to the socket and is removably mounted to the tube. The clip body defines a retaining space facing inwardly toward an interior of the article of furniture and adapted for retaining the tube.

Another object of the disclosure is to provide a canopy bow assembly that can alleviate at least one of the drawbacks of the prior art.

According to the disclosure, the canopy bow assembly is adapted to be mounted to an article of furniture including a tube, and includes a snap clip and a canopy bow. The snap clip includes a socket and a clip body. The socket defines a mounting space therein. The clip body is connected to the socket and is removably mounted to the tube. The clip body defines a retaining space facing inwardly toward an interior of the article of furniture and adapted for retaining the tube. The canopy bow is mounted in the mounting space of the socket, and is adapted to support a canopy.

The advantages of the disclosure are that: the retaining space of the snap clip is facing inwardly rather than facing downwardly, such that the canopy bow is prevented from being easily pulled off or pulled inside by an occupant; and the canopy bow assembly can be attached to the article of furniture without any additional fasteners and without any alteration or modification to the article of furniture.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating a first embodiment of a canopy bow assembly according to the disclosure mounted to an article of furniture;

FIG. 2 is an enlarged partial view of the rectangular region II in FIG. 1, illustrating a snap clip and a canopy bow of the canopy bow assembly;

FIG. 3 is a top view illustrating the snap clip being pushed toward a tube of the article of furniture;

FIG. 4 is a top view similar to FIG. 3, illustrating the snap clip being rotated relative to the tube with a resilient arm thereof abutting against the tube;

FIG. 5 is a fragmentary side view illustrating the canopy bow assembly;

FIG. 6 is a partial view illustrating a modification of the canopy bow assembly according to the disclosure;

FIG. 7 is a perspective view illustrating the modification of the canopy bow assembly mounted to the article of furniture;

FIG. 8 is a perspective view illustrating a snap clip of a second embodiment of the canopy bow assembly according to the disclosure; and

FIG. 9 is a partial view illustrating the snap clip mounted to an article of furniture.

### DETAILED DESCRIPTION

The disclosure will now be described in greater detail. It should be noted that where considered appropriate, reference numerals or terminal portions of reference numerals have been repeated among the figures to indicate corresponding or analogous elements, which may optionally have similar characteristics.

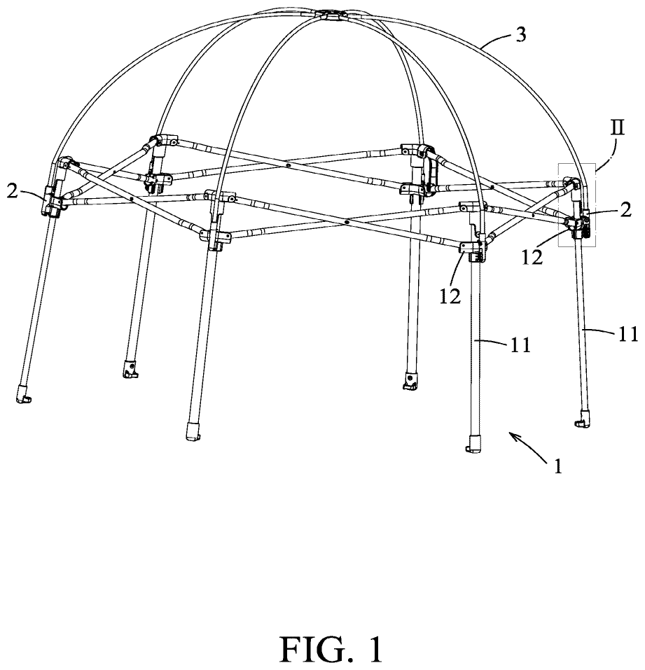

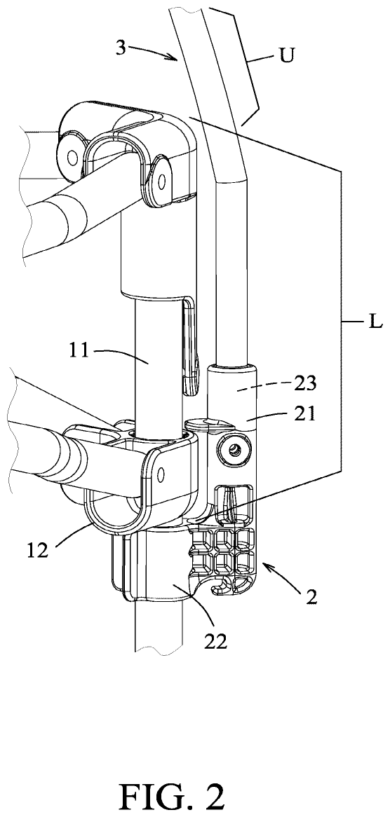

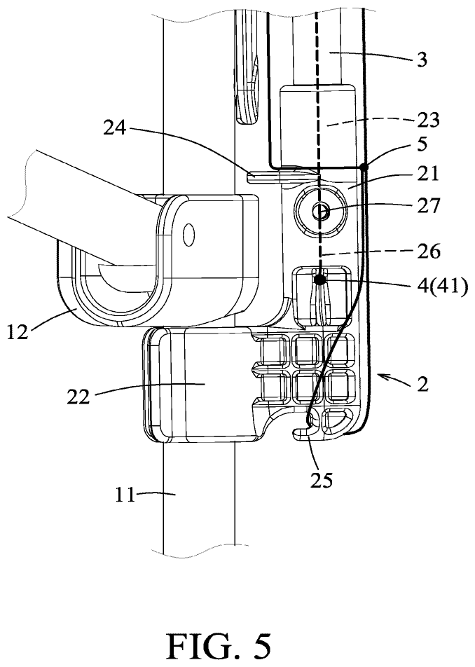

Referring to FIGS. 1 and 2, a first embodiment of the canopy bow assembly according to the disclosure is mounted onto an article of furniture, which is exemplarily a playard 1, for supporting a canopy 5 (see FIG. 5) that provides shade for the playard 1. The playard 1 includes a plurality of tubes 11, and a plurality of linking members 12 that are respectively mounted to the tubes 11. The canopy bow assembly includes a canopy bow 3, and two snap clips 2 that are respectively mounted to two opposite ends of the canopy bow 3. The snap clips 2 are substantially the same in structure. For the sake of brevity, only one snap clip 2 will be described in detail in the following paragraphs.

The snap clip 2 includes a socket 21 and a clip body 22. The socket 21 defines a mounting space 23 therein. The clip body 22 is connected to the socket 21 and is removably mounted to the tube 11. The canopy bow 3 is mounted in the mounting space 23 of the socket 21, and is for supporting the canopy 5.

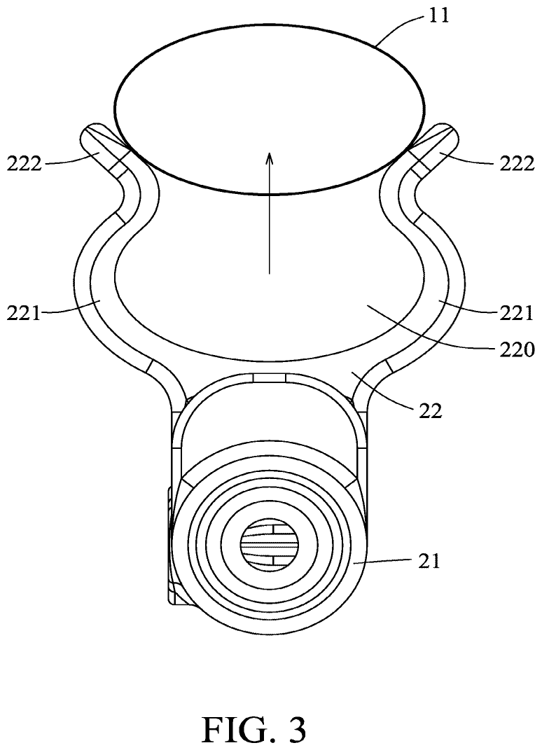

Referring further to FIG. 3, the clip body 22 includes two resilient arms 221 that cooperatively define a retaining space 220 away from the socket 21 (i.e., facing inwardly toward an interior of the playard 1) for retaining the tube 11. The resilient arms 221 are contoured to the profile (cross-section, indicated as an oval shape in FIG. 3) of the tube 11. In one embodiment, the resilient arms 221 are disposed in a horizontal direction, and the retaining space 220 of the snap clip 2 is facing inwardly toward the tube 11. One of the resilient arms 221 has a distal end portion 222 extending away from the socket 21 and away from another of the resilient arms 221, such that the snap clip 2 can be easily mounted onto the tube 11 by being pushed toward the tube 11 (see the arrow in FIG. 3). In this embodiment, the distal end portions 222 of the resilient arms 221 are configured to bend outward with respect to the retaining space 220. In one embodiment, the snap clip 2 is configured as a one-piece component, and the snap clip 2 can be made of plastic through an injection-molding technique. In one embodiment, the canopy bow 3 is made of plastic or fiberglass by an extrusion technique. In one embodiment, the snap clip 2 can be made of metal. In one embodiment, the clip body 22 includes only one resilient arm 221 that define the retaining space 220 facing inwardly toward the interior of the playard 1.

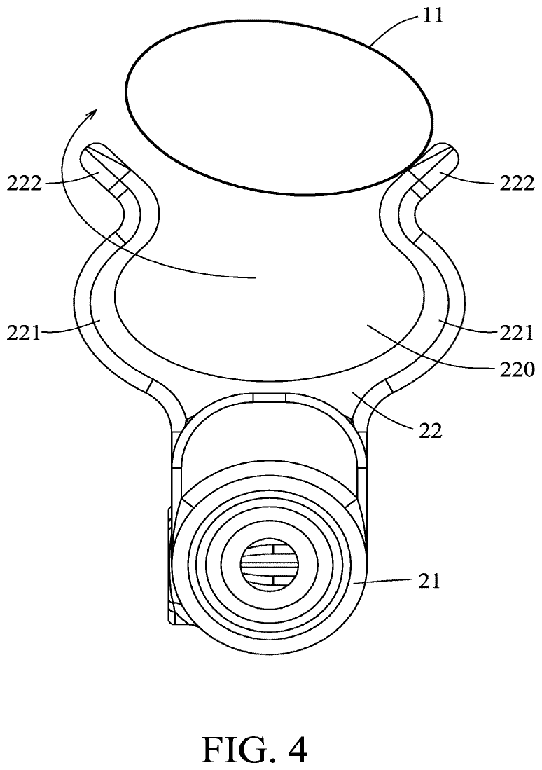

Referring further to FIG. 4, alternatively, the snap clip 2 can be mounted onto the tube 11 by rotating the snap clip 2 relative to the tube 11 after one of the resilient arms 221 makes contact with the tube 11 (see the arrow in FIG. 4) as the snap clip 2 is being pushed toward the tube 11.

Referring back to FIG. 2, preferably, the clip body 22 is adapted to be mounted to the tube 11 at a position below the linking member 12. As such, a portion (U, see FIG. 2) of the canopy bow 3 above the tube 11 is movable with the snap clip 2 mounted on the tube 11, and the canopy bow assembly would not be unintentionally detached from the playard by wind or by the occupant of the playard pulling the canopy 5. The portion (U) of the canopy bow 3 above the tube 11 is movable without separating the snap clip 2 from the tube 11. In one embodiment, the mounting space 23 extends in a direction parallel to the tube 11, such that the canopy bow assembly partially overlaps a portion of the tube 11 (see “L” in FIG. 2).

Referring to FIG. 5, in one embodiment, the snap clip 2 further includes an alignment rib 24 disposed on the socket 21 and spaced apart from the clip body 22. The alignment rib 24 is adapted to abut against a surface of the linking member 12 that faces upwardly to cooperate with the clip body 22 to limit a range of movement of the snap clip 2 after the snap clip 2 is mounted to the clip 11, so as to prevent the snap clip 2 from sliding down the tube 11.

In one embodiment, the snap clip 2 further includes a hook portion 25 disposed on the socket 21 and adapted to hook the canopy 5 supported by the canopy bow 3.

In one embodiment, the socket 21 of the snap clip 2 further defines a tunnel 26 that is in spatial communication with the mounting space 23. The canopy bow assembly further includes a resilient cord 4 extending along the canopy bow 3 through the tunnel 26, and the resilient cord 4 terminates at a knot 41. The resilient cord 4 is configured to hold multiple canopy bows 3 together.

In one embodiment, the socket 21 of the snap clip 2 is formed with a mount hole 27. The canopy bow 3 can be screwed on the snap clip 2 by a screw (not shown) and the mount hole 27. In one embodiment, the canopy bow 3 is snap-fitted to the snap clip 2.

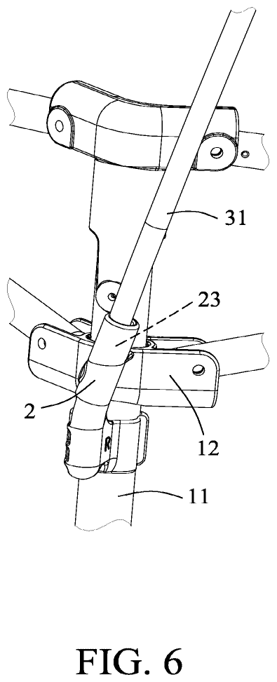

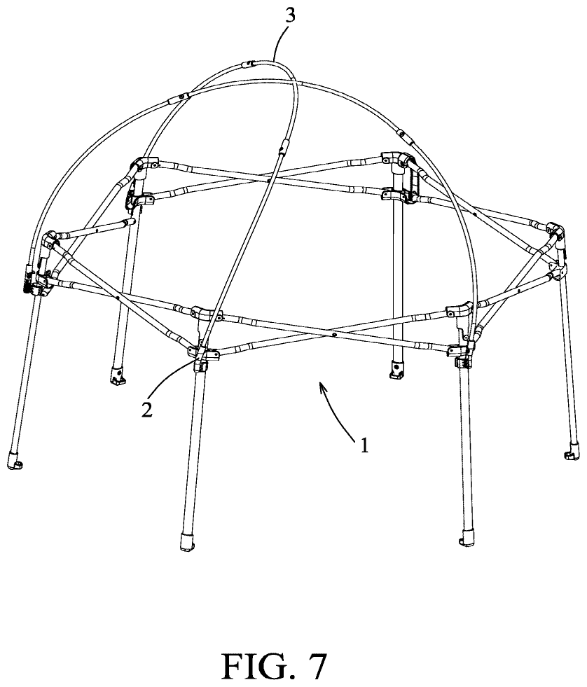

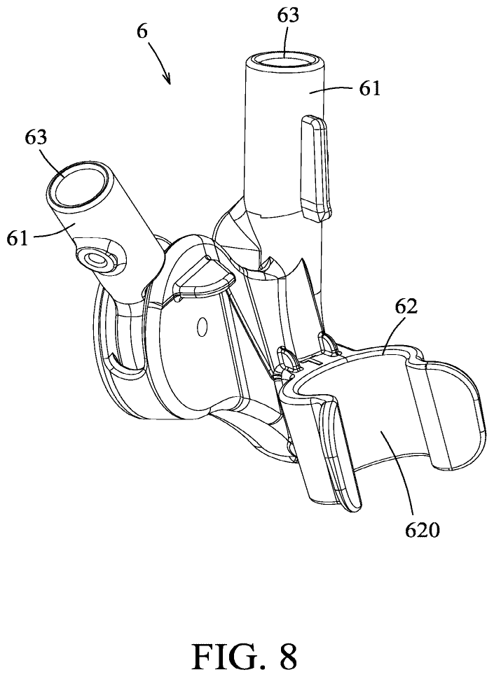

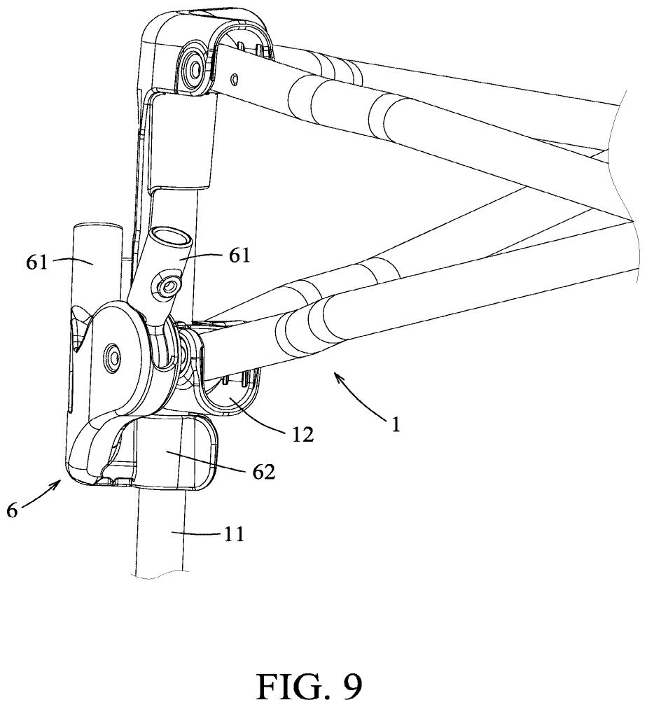

Referring to FIGS. 6 and 7, in a modification, the mounting space 23 of the snap clip 2 extends in a direction oblique to the tube 11 for the canopy bow 3 to be mounted thereto. As such, a canopy (not shown) supported by the canopy bow 3 serves to partially cover the playard 1. Referring to FIGS. 8 and 9, the snap clip 6 of a second embodiment of the canopy bow assembly according to the disclosure includes two sockets 61, and a clip body 62 that is connected to the sockets 61. The clip body 62 defines a retaining space 620, and is removably mounted to the tube 11 of the playard 1. Each of the sockets 61 defines a mounting space 63 therein, such that sockets 61 of the snap clip 6 permits two canopy bows (not shown) to respectively mounted thereto. In one embodiment, the sockets 61 are pivotally interconnected such that the canopy bows mounted to the snap clip 6 are movable relative to each other.

The advantages of the disclosure are as follows: the retaining space 220, 620 of the snap clip 2, 6 is facing inwardly rather than facing downwardly, such that the canopy bow 3 is prevented from being easily pulled off or pulled inside by an occupant; and the canopy bow assembly can be attached to the article of furniture without any additional fasteners and without any alteration or modification to the article of furniture, so the canopy bow assembly according to the disclosure can be attached onto various kinds of furniture.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A snap clip adapted to mount a canopy bow to an article of furniture, the article of furniture including a tube, said snap clip comprising:
a clip body connected to adapted to be removably mounted to the tube, said clip body defining a retaining space that is facing inwardly toward an interior of the article of furniture and that is adapted for retaining the tube.
